(19) United States
(12) Patent Application Publication
(10) Pub. No.: US 2008/0016778 A1
(43) Pub. Date: Jan. 24, 2008

(54) Channel Mount Adapter for Four-Bar Window Hinge

(75) Inventor: Malcolm Muir, Honeoye Falls, NY (US)

Correspondence Address: Stephen B. Salai, Esq.;Harter, Secrest & Emery LLP, 1600 Bausch & Lomb Place, Rochester, NY, 14604-2711, US

(73) Assignee: ADVANTAGE MANUFACTURING CORPORATION, Victor, NY (US)

(21) Appl. No.: 11/458,302

(22) Filed: Jul. 18, 2006

(51) Int. Cl. E05F 11/24

(52) U.S. Cl. 49/345; 49/339

(57) ABSTRACT

An adapter system for mounting conventional four-bar hinges within window assemblies that include elongated channels for mounting window hardware. One or more clamps having attachment features aligned with openings in a linkage bar of the four-bar hinges are received within the elongated channels of window sashes. The attachment features provide for aligning the linkage bars to the channels and for both temporarily and more permanently securing the vent bars to the channels.

### FIELD OF THE INVENTION

The invention relates to window hardware, including linkage assemblies for pivotally supporting windows about vertical or horizontal axes, and to mounting systems for such linkage assemblies.

### BACKGROUND OF THE INVENTION

A window hardware mounting system, featuring elongated channels referred to as “Euro-Grooves”, provides a convenient and standardized way of attaching window hardware and accessory options to sashes and frames of window assemblies. The channels have a T-shaped cross section, comprising a channel bottom and two sidewalls with overhanging rails. Hardware can be slid along the channels to desired positions and anchored to the overhanging rails of the sidewalls. Such channel-mount systems can reduce costly alignment, drilling, and other operations required to mount window hardware directly to sashes or window frames.

The window hardware intended for mounting by way of the elongated channels is typically designed with mounting components that are specially sized and shaped for engaging the elongated channels. For example, my earlier U.S. patent application Ser. No. 10/908,696 entitled Channel-Mounted 4-Bar Linkage Assembly, which is hereby incorporated by reference, discloses a vent bar that is specially sized and shaped to be slid along an elongated window channel.

However, many window manufactures maintain substantial inventories of conventional four-bar linkage assemblies, and at least some of these manufactures prefer to use these already qualified four-bar linkage designs rather than requalify and stock additional designs for engaging the elongated channels. Doubling inventory units and testing new designs can be costly. Accordingly, a need exists for adapting existing inventories of conventional four-bar linkage assemblies to benefit from the mounting advantages of elongated channels.

### SUMMARY OF INVENTION

The invention among its preferred embodiments features an adapter system that allows conventional four-bar linkage assemblies to be mounted in window frames having elongated channel mounts. For example, a special adapter for attaching a vent bar of a so-called 4-bar linkage assembly to a window sash includes one or more clamps that fit within the elongated channel. The clamps are attached to the vent bar through existing apertures, and one or more fasteners also addressable through existing apertures lock the clamps in place within the elongated channels.

Existing apertures in the bars of 4-bar linkage assemblies, which are intended for mounting the bars directly to window sashes or frames, can be used to attach the clamps to the bars and to fasten the clamps to the elongated channels of conventional channel-mounts. The clamps are preferably slideable along the channels for locating the bars with respect to the window sash or frame. The fasteners secure the clamps to the channels in a desired position.

One version of the invention as a window hinge adapted for a channel mount of a window assembly includes the usual features of (a) an elongated track for attachment to a window frame, (b) a vent bar for attachment to a window sash, and (c) a linkage mechanism connecting the vent bar to the elongated track for pivoting and translating the vent bar with respect to the elongated track. In addition, the new window hinge includes a clamp that is slideable along a channel of the window sash and has ears that are sized to extend beneath overhanging rails on opposite sides of the channel. At least one fastener fastens the vent bar to the clamp between the overhanging rails of the channel.

The vent bar is preferably of the type that has a length and a plurality of mounting holes spaced apart along its length. One of the fasteners preferably extends through one of the mounting holes into engagement with the clamp. For example, the one fastener can be arranged as a compression fastener that draws the vent bar and the clamp together for capturing the overhanging rails of the channel between the vent bar and the ears of the clamp. Another fastener can be arranged as an extension fastener that extends from the clamp into a frictional engagement with a bottom of the channel. The extension fastener is preferably accessible through another one of the mounting holes in the vent bar for moving the extension fastener into the frictional engagement with the bottom of the channel.

The clamp can also include a post projecting into engagement with another one of the mounting holes in the vent bar for locating the clamp with respect to the vent bar. A locating stop can be formed at one end of the clamp for engaging an end wall of the channel. The locating stop preferably includes a locating tool that is removably mounted at the one end of the clamp.

For adapting to different length vent bars, the clamp can be one of a pair of clamps, each of which is slideable along the channel and has ears that are sized to extend beneath the overhanging rails of the channel. A first of the fasteners can be arranged to extend through a first of the mounting holes into engagement with a first of the pair of clamps, and a second of the fasteners can be arranged to extend through a second of the mounting holes into engagement with a second of the pair of clamps. The first and second fasteners are preferably compression fasteners that draw the vent bar and the clamps together for capturing the overhanging rails between the vent bar and the ears of the clamps.

An extension fastener that extends from the second clamp can be drawn into a frictional engagement with a bottom of the channel. The extension fastener is preferably accessible through a third of the mounting holes in the vent bar for moving the extension fastener into the frictional engagement with the bottom of the channel. A post can be arranged to project from the first clamp into engagement with a fourth of the mounting holes in the vent bar for locating the first clamp with respect to the vent bar. A locating stop can be arranged at one end of the second clamp for engaging an end wall of the channel. The locating stop preferably includes a locating tool that is removably mounted at the one end of the second clamp.

Another version of the invention improves upon a window sash mounting system of a type including a four-bar hinge for mounting the window sash to a window frame. The four-bar hinge has an elongated track for attachment to the window frame and a vent bar for attachment to the window sash. The vent bar has a length and mounting holes distributed along its length for attaching the vent bar directly to the window sash. The improvement includes the addition of a clamp that mountable within a channel of the window sash and a plurality of fasteners that are operable through the mounting holes in the vent bar for connecting the vent bar to the clamp. The clamp has ears that are engageable with overhanging rails of the channel. The fastener also provides for moving the ears of the clamp into engagement with the overhanging rails of the channel for attaching the vent bar to the window sash.

The channel has a bottom and two sides that extend along a length of the channel and the rails overhang the bottom of the channel from the two sides. The ears of the clamp are preferably sized to extend beneath the overhanging rails on the two sides of the channel.

The clamp as preferably configured has a generally T-shaped profile in cross section for forming an interlocking joint with the channel. The fasteners that are preferably operable through the mounting holes in the vent bar and include a compression fastener that draws the vent bar and the clamp together for capturing the overhanging rails of the channel between the vent bar and the ears of the clamp. The fasteners that are operable through the mounting holes in the vent bar also preferably include an extension fastener that extends from the clamp into a frictional engagement with the bottom of the channel. The extension fastener is preferably accessible through one of the mounting holes in the vent bar for moving the extension fastener into the frictional engagement with the bottom of the channel.

A post projecting from the clamp into engagement with one of the mounting holes in the vent bar can be used for locating the clamp with respect to the vent bar. In addition, a locating stop at one end of the clamp can be used for engaging an end wall of the channel. The locating stop can include a locating tool that is removably mounted at the one end of the clamp.

The clamp can be one of a pair of clamps, each of which is mountable along the channel of the window sash and has ears that are engageable with the overhanging rails of the channel. The fasteners can include first and second compression fasteners that extend through the mounting holes into engagement with first and second clamps of the pair for drawing the vent bar and the clamps together to capture the overhanging rails between the vent bar and the ears of the clamps. The fasteners can also include an extension fastener that extends from one of the first and second clamps into a frictional engagement with a bottom of the channel. A locating stop at one end of the second clamp can be used for engaging an end wall of the channel.

Another version of the invention as a channel mounting system can be specifically adapted to a hinge assembly having an elongated track, a slider movable along the elongated track, a brace pivotally mounted on the slider, a strut pivotally mounted in common with the elongated track, and a carrier arm having mounting holes distributed along its length pivotally connected to both the brace and the strut. First and second clamps have mounting features aligned with different groupings of the mounting holes of the carrier arm. The first and second clamps are slideable along a channel between sidewalls that include portions that overhang the clamps. Fasteners operable through the aligned mounting holes of the carrier arm act in cooperation with the mounting features of the first and second clamps for drawing the first and second clamps together with the carrier arm.

At least one of the fasteners preferably fixes a position of one of the first and second clamps along the channel. The mounting features can include at least one post that engages one of the aligned mounting holes for orienting at least one of the first and second clamps. Other of the mounting features can include openings in each of the first and second clamps for receiving the fasteners that are operable through the aligned mounting holes for drawing the first and second clamps together with the carrier arm. A locating stop at one end of one of the first and second clamps can be used for engaging an end wall of the channel. The first and second clamps also preferably include stepped sidewalls joined by intermediate surfaces.

The invention can also be practiced as a method of adapting an inventory of conventional four-bar hinges having mounting holes arranged in vent bars for receiving fasteners that attach the vent bars directly to window sashes for use with different window sashes having interlocking channels for mounting window hardware. Slideable along the interlocking channels are clamps that include mounting features that are moved into alignment with the mounting holes of the vent bars. Once in place, the clamps are fastened to the vent bars through the aligned mounting holes in cooperation with the mounting features of the clamps for drawing the clamps together with the vent bars.

The fasteners are preferably operable through the aligned mounting holes for attaching the clamps to the channels. The clamps can be arranged in groups and fastened to individual vent bars. A locating stop can be provided at one end of one of the clamps in each group of clamps for locating the individual vent bars along the channels.

Another version of the invention as a method of mounting a vent bar of a four-bar hinge to a window sash having an interlocking channel includes attaching a clamp to the vent bar forming grooves that extend along a common length of the vent bar and the clamp. The attached clamp can be slid along the capturing overhanging rails of the channel within the grooves that extend along the common length of the vent bar and the clamp. The attached clamp can be locked to the channel for attaching the vent bar to the window sash. The attached clamp can be slid until a locating stop on the clamp engages a feature of the channel. An adjustable fastener temporarily locks the attached clamp to the channel for testing the position of the vent bar with respect to the window sash. Locking can also include driving a fastener through the vent bar into the window sash for more permanently attaching the vent bar to the window sash.

The openings and other features for connecting the clamps to the vent bars can be offset with respect to centerlines of the clamps to position the sashes with respect to their window frames. The clamp features can also be arranged or duplicated symmetrically from each end of the clamps so that the same clamps can be used for mounting hinges on opposite sides of the same sash or for mounting sashes that open from opposite directions.

### BRIEF DESCRIPTION OF THE DRAWING FIGURES

FIG. 1 is a front view of a four-bar hinge attached to a window frame and having an adapter clamp aligned for entering an elongated slot in a window sash member.

FIG. 2 is a back view of the four-bar hinge mounted between the window frame and sash with the clamp received within the elongated slot of the window sash member.

FIG. 3 is a perspective view of the four-bar hinge attached to the window frame and showing by way of an exploded view the attachment of the clamp to a vent bar of the four-bar hinge.

FIG. 4 is an end view of the four-bar hinge mounted in place between the elongated channels of the window sash and frame.

FIG. 5 is a front view of a similar four-bar hinge attached to the window frame and having a pair of clamps aligned for entering the elongated slot in the window sash member.

FIG. 6 is a back view of the four-bar hinge mounted between the window frame and sash with the pair of clamps received within the elongated slot of the window sash member.

FIG. 7 is a perspective view of the four-bar hinge attached to the window frame and showing by way of an exploded view the attachment of the pair of clamps to the vent bar of the four-bar hinge.

### DETAILED DESCRIPTION

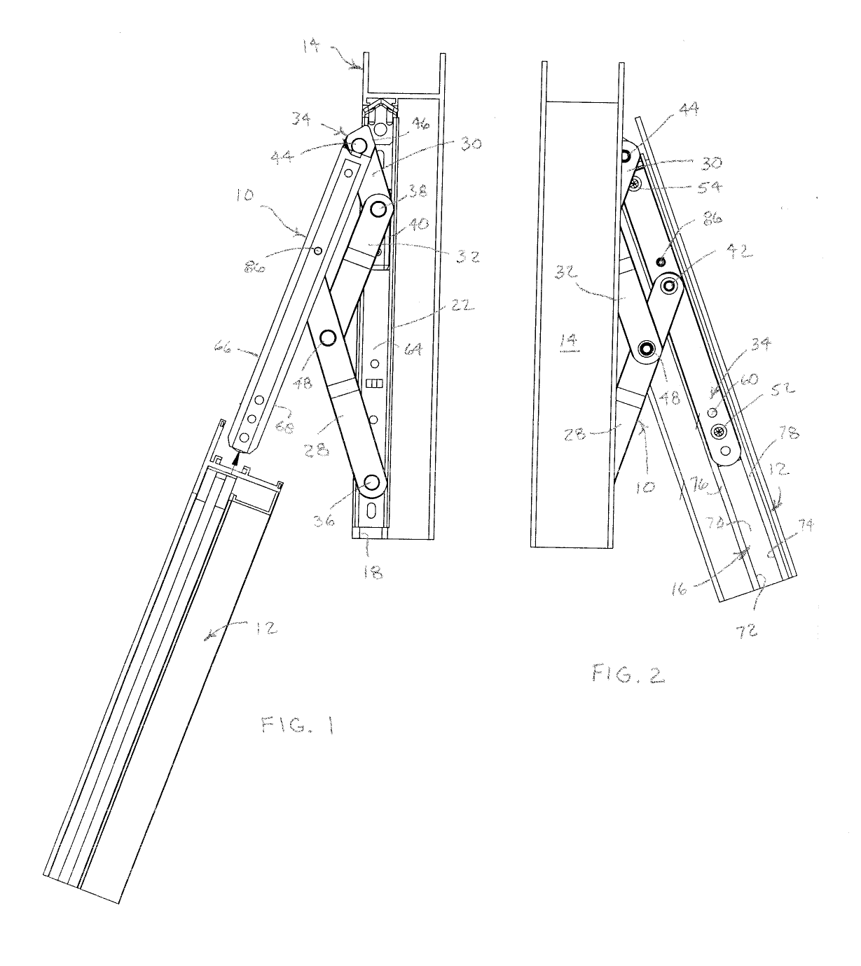

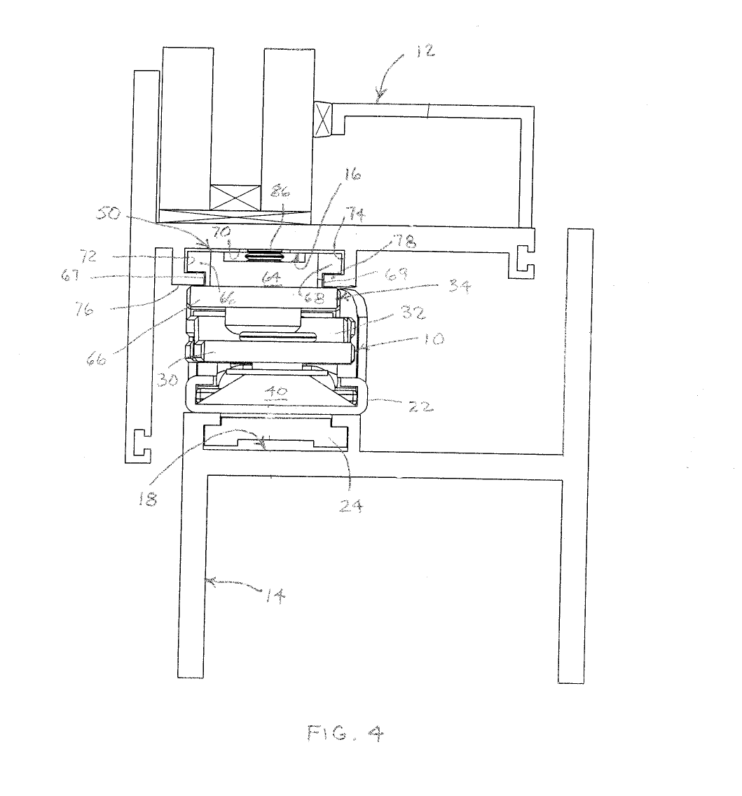

A four-bar hinge 10 adapted for purposes of the invention is shown in FIGS. 1-4 for pivotally mounting a window sash 12 within a window frame 14. Except for its further adaptation to the elongated channels 16 and 18, the four-bar hinge 10 has a conventional configuration.

An elongated track 22 of the four-bar hinge 10 is attached to the window frame 14 through a bracket 24 (shown in FIG. 4). Screws (not shown) extend through openings in the track 22 into threaded engagements with the bracket 24 to draw the bracket and the track 22 together against overhanging rails of the elongated channel 18.

Intermediate linkage bars 28, 30, and 32 connect a vent bar 34 (also referred to as a carrier arm) to the track 22. One end of the intermediate linkage bar 28, also referred to as a strut, attaches to the track 22 through a first pivot pin 36. Overlapping ends of the intermediate linkage bars 30 and 32 attach to the track 22 through a second pivot pin 38 that projects from a shoe 40 (also referred to as a slider). The second pivot pin 38 is slideable as a part of the shoe 40 along the track 22. The opposite ends of the intermediate linkage bars 28 and 30 attach to the vent bar 34 through third and fourth pivot pins 42 and 44. The fourth pivot pin 42 attaches the intermediate linkage bar 28 to the vent bar 34 along a mid-length of the vent bar 34. The fifth pivot pin 44 attaches the intermediate linking bar 30 to a cam end 46 of the vent bar 34. The opposite end of the intermediate linkage bar 32, also referred to as a brace, attaches to the intermediate linkage bar 28 through a sixth pivot pin 48. Pivotal motion of the vent bar 34 with respect to the track 22 is accompanied by a translation of the vent bar 34 through a sliding motion of the shoe 38 along the track 22.

A clamp 50 is attached to the vent bar 34 through screws 52 and 54 (compression fasteners) that extend through existing openings in the form of slots 56 and 58. A post 60 of the clamp 50 is aligned with a similarly sized mounting hole 62 in the vent bar 34 for locating the clamp 50 along a length of the vent bar 34. The clamp 50 has a generally T-shaped cross section (see FIG. 4) with a center section 64 and two ears 66 and 68 that project from opposite sides of the center section 64. The center section 64 and the two ears 66 and 68 extend along substantially the entire length of the clamp 50. The two ears 66 and 68 form together with the attached vent bar 34 a pair of parallel grooves 67 and 69 that extend along a common length of the vent bar 34 and the clamp 50. The T-shaped cross section of the clamp 50 supports a sliding fit with the elongated channel 16.

The elongated channels 16 and 18 of the sash 12 and window frame 14 are intended for mounting window hardware, such as may be consistent with so-called “Euro-Groove” systems. The channel 16 has a bottom 70 and two sidewalls 72 and 74 with overhanging rails 76 and 78. The center section 64 of the clamp 50 extends between the overhanging rails 76 and 78, and the two ears 66 and 68 extend beneath the overhanging rails 76 and 78.

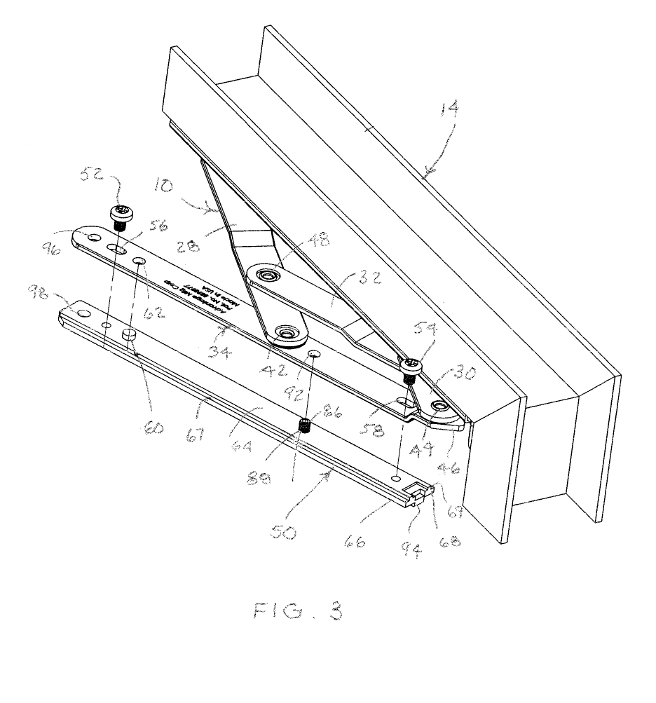

As shown in FIGS. 1 and 2, the sash 12 together with its elongated channel 16 can be aligned with the clamp 50 projecting from the vent bar 34 for sliding the clamp 50 along the elongated channel 16 to a desired position for mounting the sash 12 within the frame 14. For adjusting the mounting location of the vent bar 34 with respect to the sash 12, the screws 52 and 54 are loosely held in engagement with threaded holes 82 and 84 of the clamp 50. A setscrew 86 (an extension fastener), which engages a mating threaded opening 88 in the clamp 50, is accessible through an aligned opening 92 in the vent bar 34. The setscrew 86 can be turned into frictional engagement with the bottom 70 of the channel 16 for temporarily holding the vent bar 34 in place along the channel 16. Thereafter, the screws 52 and 54 can be tightened to press the clamp 50 together with the vent bar 34 against the overhanging rails 76 and 78 of the channel 16. A stop 94 formed at one end of the clamp 50 can be used to engage one end of the channel 16 for initially positioning the vent bar 34 along the channel 16. Further adjustments of the vent bar 34 with respect to the channel 16 can be referenced to the initial position of the stop 94. Once finally positioned, a screw (not shown) can be driven through aligned openings 96 and 98 of the vent bar 34 and the clamp 50 into the window sash 12.

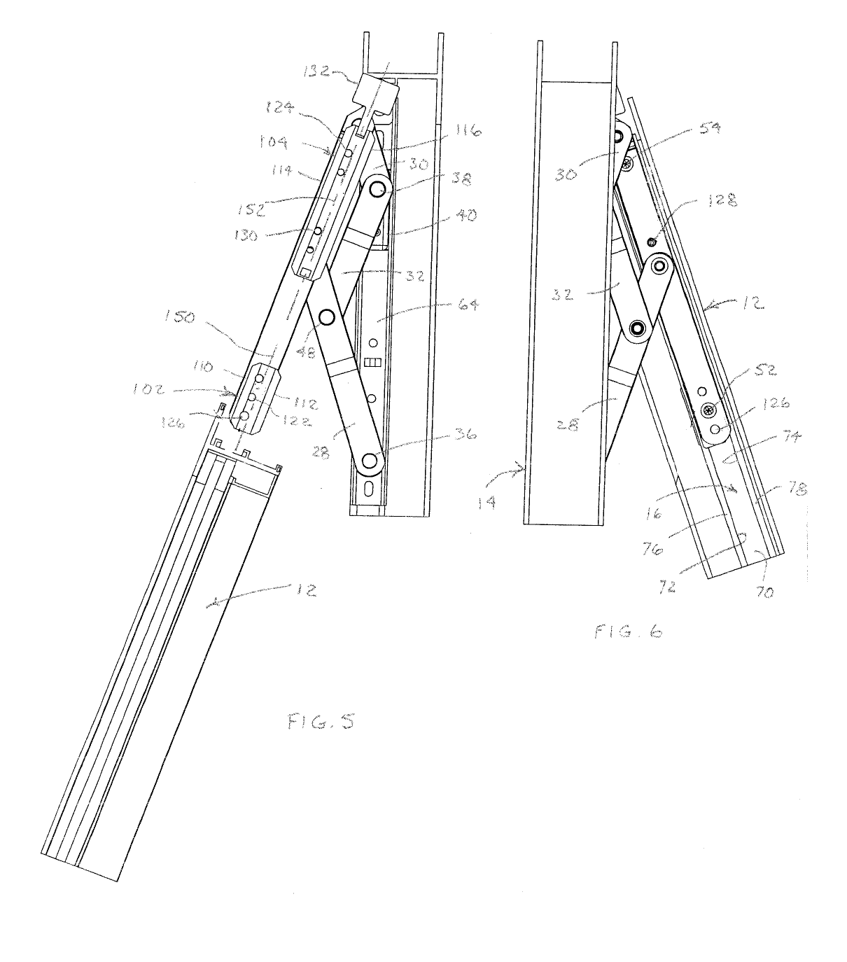

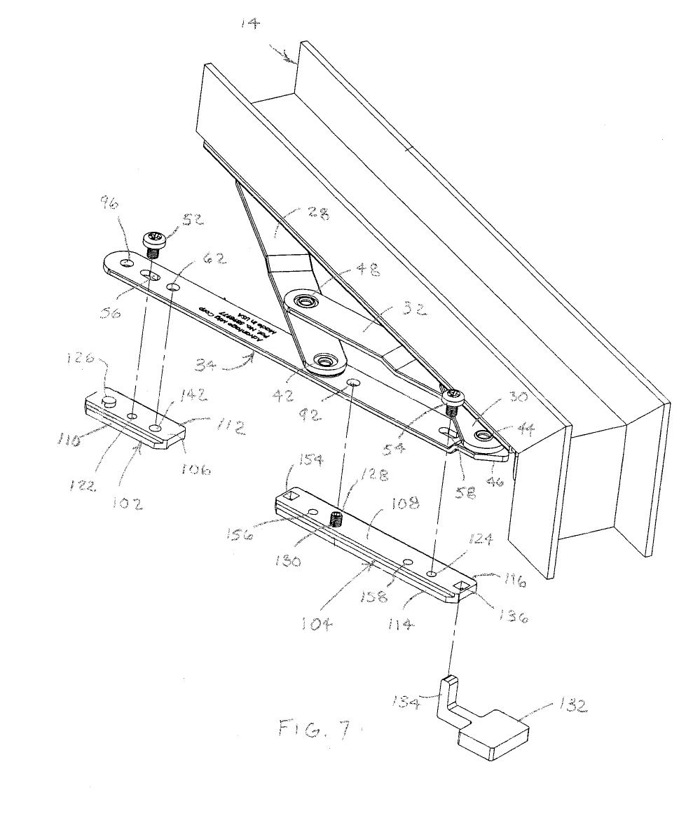

The same four-bar-hinge 10 appears in FIGS. 5-7 together with a pair of clamps 102 and 104 for attaching opposite ends of the vent bar to the elongated channel 16 of the window sash 12. Both clamps 102 and 104 have a center section 106 or 108 and two ears 110 and 112 or 114 and 116 forming a T-shaped cross section that fits within the similarly shaped elongated channel 16 of the sash 12. Although the two clamps 102 and 104 are shown mounted on the same vent bar 34 as the preceding embodiment, the two clamps 102 and 104 also provide for more readily accommodating different length vent bars associated with hinges of different size.

Each of the clamps 102 and 104 engages the vent bar 34 in at least two places. Screws 52 and 54 pass through the elongated openings 56 and 58 in the vent bar 34 and engage threaded openings 122 and 124 in the clamps 102 and 104. The clamp 102 also includes a post 126 that engages a similarly sized opening 96 in the vent bar 34. A setscrew 128 engages a threaded opening 130 through the clamp 104 for engaging the bottom 70 of the elongated channel 16. The setscrew 128 is accessible through the aligned opening 92 in the vent bar 34. The screw 52 and the post 126 align the clamp 102 to the vent bar 34, and the screw 54 and the setscrew 128 align the clamp 104 to the vent bar 34.

A removable locating tool 132 includes a post 134 for engaging a similarly shaped opening 136 in the clamp 104. The post 134 is also arranged to engage one end of the sash channel 16 for initially positioning the vent bar 34 together with the two clamps 102 and 104 along the sash channel 16. Adjustments can be made with respect to the initial position of the vent bar 34, and the vent bar 34 can be temporarily held in place by engaging the setscrew 128 with the bottom 70 of the sash channel 16. The vent bar 34 can be more securely held in place by tightening the screws 52 and 54 to squeeze the overhanging rails 72 and 74 of the sash channel 16 between the vent bar 34 and the ears 110, 112 and 114, 116 of the two clamps 102 and 104. A screw (not shown) can be driven through the opening 62 in the vent bar 34 and an aligned opening 142 in the clamp 102 into engagement with the sash 12 as an even more permanent connection.

Some offset may be necessary for mounting the vent bar 34 with respect to the sash channel 16 for properly opening and closing the window sashes, and the clamps 102 and 104 are arranged to provide such offset for mounting the sash 12. The two referenced openings 122 and 142 and the post 126 of the clamp 102 and the two referenced openings 124 and 130 of the clamp 104 are similarly offset with respect to centerlines 150 and 152 of the clamps 102 and 104.

However, to maintain the same offset on opposite sides of the same window sash or between abutting window sashes, the offset provided by the two clamps 102 and 104 must be reversed. To accomplish this with the same two clamps 102 and 104, the two clamps 102 and 104 are made end-to-end symmetric so that the same patterns of features are referenced from both ends. For example, the post 126 and the opening 142 are equidistant from the center opening 122 of the clamp 102, so the clamp 102 can be rotated 180 degrees while still maintaining alignment with the three openings 96, 56, and 62 of the vent bar 34. The required symmetry is achieved in the clamp 104 by providing additional openings. For example, an opening 154 is formed in an opposite end of the clamp 104 for receiving the post 134 of the locating tool 132. In addition, a threaded opening 156 is formed adjacent to the opening 154 for receiving the screw 54, and a threaded opening 158 is formed closer to the opposite end of the clamp 104 for receiving the setscrew 128 in the new orientation.

Although described with respect to a limited number of embodiments, those of skill in this art will readily appreciate the many possible variations and adaptations of this invention within its overall teaching.

1. A window hinge adapted for a channel mount of a window assembly comprising
an elongated track for attachment to a window frame,
a vent bar for attachment to a window sash,
a linkage mechanism connecting the vent bar to the elongated track for pivoting and translating the vent bar with respect to the elongated track,
a clamp that is slideable along a channel of the window sash and has ears that are sized to extend beneath overhanging rails on opposite sides of the channel, and
at least one fastener for fastening the vent bar to the clamp between the overhanging rails of the channel.

2. The hinge of claim 1 in which the vent bar has a length and includes a plurality of mounting holes spaced apart along its length, and the at least one fastener extends through one of the mounting holes into engagement with the clamp.

3. The hinge of claim 2 in which the at least one fastener includes a compression fastener that draws the vent bar and the clamp together for capturing the overhanging rails of the channel between the vent bar and the ears of the clamp.

4. The hinge of claim 3 further comprising an extension fastener that extends from the clamp into frictional engagement with a bottom of the channel.

5. The hinge of claim 4 in which the extension fastener is accessible through another one of the mounting holes in the vent bar for moving the extension fastener into the frictional engagement with the bottom of the channel.

6. The hinge of claim 2 further comprising a post projecting from the clamp into engagement with another one of the mounting holes in the vent bar for locating the clamp with respect to the vent bar.

7. The hinge of claim 1 further comprising a locating stop at one end of the clamp for engaging an end wall of the channel.

8. The hinge of claim 7 in which the locating stop includes a locating tool that is removably mounted at the one end of the clamp.

9. The hinge of claim 2 in which the clamp is one of a pair of clamps, each of which being slideable along the channel and having ears that are sized to extend beneath the overhanging rails of the channel.

10. The hinge of claim 9 in which the at least one fastener is a first of a plurality of fasteners, the first fastener extending through a first of the mounting holes into engagement with a first of the pair of clamps and a second of the plurality of fasteners extending through a second of the mounting holes into engagement with a second of the pair of clamps.

11. The hinge of claim 10 in which the first and second fasteners are compression fasteners that draw the vent bar and the clamps together for capturing the overhanging rails between the vent bar and the ears of the clamps.

12. The hinge of claim 11 further comprising an extension fastener that extends from the second clamp into a frictional engagement with a bottom of the channel.

13. The hinge of claim 12 in which the extension fastener is accessible through a third of the mounting holes in the vent bar for moving the extension fastener into the frictional engagement with the bottom of the channel.

14. The hinge of claim 13 further comprising a post projecting from the first clamp into engagement with a fourth of the mounting holes in the vent bar for locating the first clamp with respect to the vent bar.

15. The hinge of claim 10 further comprising a locating stop at one end of the second clamp for engaging an end wall of the channel.

16. The hinge of claim 15 in which the locating stop includes a locating tool that is removably mounted at the one end of the second clamp.

17. In a window sash mounting system of a type including a four-bar hinge for mounting the window sash to a window frame, the four-bar hinge having an elongated track for attachment to the window frame and a vent bar for attachment to the window sash, the vent bar having a length and mounting holes distributed along its length for attaching the vent bar directly to the window sash, the improvement comprising
a clamp mountable within a channel of the window sash, the clamp having ears that are engageable with overhanging rails of the channel, and
a plurality of fasteners that are operable through the mounting holes in the vent bar for connecting the vent bar to the clamp and for moving the ears of the clamp into engagement with the overhanging rails of the channel for attaching the vent bar to the window sash.

18. The system of claim 17 in which the channel has a bottom and two sides that extend along a length of the channel and the overhanging rails overhang the bottom of the channel from the two sides and in which the ears of the clamp are sized to extend beneath the overhanging rails on the two sides of the channel.

19. The system of claim 18 in which the clamp has a generally T-shaped profile in cross section for forming an interlocking joint with the channel.

20. The system of claim 18 in which the fasteners that are operable through the mounting holes in the vent bar include a compression fastener that draws the vent bar and the clamp together for capturing the overhanging rails of the channel between the vent bar and the ears of the clamp.

21. The system of claim 20 in which the fasteners that are operable through the mounting holes in the vent bar include an extension fastener that extends from the clamp into a frictional engagement with the bottom of the channel.

22. The system of claim 21 in which the extension fastener is accessible through one of the mounting holes in the vent bar for moving the extension fastener into the frictional engagement with the bottom of the channel.

23. The system of claim 18 further comprising a post projecting from the clamp into engagement with one of the mounting holes in the vent bar for locating the clamp with respect to the vent bar.

24. The system of claim 17 further comprising a locating stop at one end of the clamp for engaging an end wall of the channel.

25. The system of claim 24 in which the locating stop includes a locating tool that is removably mounted at the one end of the clamp.

26. The system of claim 17 in which the clamp is one of a pair of clamps, each of which being mountable within the channel of the window sash and having ears that are engageable with the overhanging rails of the channel.

27. The system of claim 26 in which the plurality of fasteners include first and second compression fasteners that extend through the mounting holes into engagement with first and second clamps of the pair for drawing the vent bar and the clamps together to capture the overhanging rails between the vent bar and the ears of the clamps.

28. The system of claim 27 in which the plurality of fasteners also include an extension fastener that extends from the one of the first and second clamps into a frictional engagement with a bottom of the channel.

29. The system of claim 17 further comprising a locating stop at one end of the second clamp for engaging an end wall of the channel.

30. A channel mounting system for a hinge assembly having an elongated track, a slider movable along the elongated track, a brace pivotally mounted on the slider, a strut pivotally mounted in common with the elongated track, and a carrier arm having mounting holes distributed along its length pivotally connected to both the brace and the strut comprising
first and second clamps having mounting features aligned with different groupings of the mounting holes of the carrier arm,
the first and second clamps being slideable along a channel between sidewalls that include portions that overhang the clamps, and
fasteners operable through the aligned mounting holes of the carrier arm in cooperation with the mounting features of the first and second clamps for drawing the first and second clamps together with the carrier arm.

31. The system of claim 30 in which the fasteners include at least one fastener for fixing a position of one of the first and second clamps along the channel.

32. The system of claim 30 in which the mounting features include at least one post that engages one of the aligned mounting holes for orienting at least one of the first and second clamps.

33. The system of claim 32 in which other of the mounting features include openings in each of the first and second clamps for receiving the fasteners that are operable through the aligned mounting holes for drawing the first and second clamps together with the carrier arm.

34. The system of claim 30 further comprising a locating stop at one end of one of the first and second clamps for engaging an end wall of the channel.

35. The system of claim 30 in which each of the first and second clamps include stepped sidewalls joined by intermediate surfaces, and grooves are formed between the carrier arm and the intermediate surfaces of the first and second clamps.

36. The system of claim 30 in which the first and second clamps have a central axes and the mounting features are offset with respect to the central axes for mounting the carrier arm offset with respect to the channel.

37. A method of adapting an inventory of four-bar hinges of a type having mounting holes arranged in vent bars for receiving fasteners for attaching the vent bars directly to window sashes for use with different window sashes having interlocking channels for mounting window hardware comprising steps of
aligning mounting features of clamps with the mounting holes of the vent bars, the clamps being slideable along the interlocking channels between sidewalls that include portions that overhang the clamps, and
fastening the clamps to the vent bars through the aligned mounting holes in cooperation with the mounting features of the clamps for drawing the clamps together with the vent bars.

38. The method of claim 37 including a step of mounting additional fasteners from the clamps, which are operable through the aligned mounting holes for attaching the clamps to the channels.

39. The method of claim 37 including a step of arranging the clamps in groups and fastening the groups of clamps to individual vent bars.

40. The method of claim 39 including a step of providing a locating stop at one end of one of the clamps in each group of clamps for locating the individual vent bars along the channels.

41. A method of mounting a vent bar of a four-bar hinge to a window sash having an interlocking channel comprising steps of
attaching a clamp to the vent bar forming grooves that extend along a common length of the vent bar and the clamp,
sliding the attached clamp into the channel capturing overhanging rails of the channel within the grooves that extend along the common length of the vent bar and the clamp, and
locking the attached clamp to the channel for attaching the vent bar to the window sash.

42. The method of claim 41 in which the step of sliding the attached clamp includes sliding the attached clamp until a locating stop on the clamp engages a feature of the channel.

43. The method of claim 41 in which the step of locking includes using an adjustable fastener to temporarily lock the attached clamp to the channel for testing the position of the vent bar with respect to the window sash.

44. The method of claim 43 in which the step of locking also includes driving a fastener through the vent bar into the window sash for more permanently attaching the vent bar to the window sash.
